(19) United States
(12) Patent Application Publication
(10) Pub. No.: US 2014/0040302 A1
(43) Pub. Date: Feb. 6, 2014

(54) METHOD AND SYSTEM FOR DEVELOPING A LIST OF WORDS RELATED TO A SEARCH CONCEPT

(71) Applicant: Patrick Sander Walsh, Arlington, VA (US)

(72) Inventor: Patrick Sander Walsh, Arlington, VA (US)

(21) Appl. No.: 13/889,567

(22) Filed: May 8, 2013

Related U.S. Application Data
(60) Provisional application No. 61/644,261, filed on May 8, 2012.

(51) Int. Cl. G06F 17/30

(52) U.S. Cl. CPC G06F 17/30976
USPC 707/766; 707/765

(57) ABSTRACT

The present invention is a method and system for enhancing the output of standard thesaurus databases. The user requires little knowledge of the meaning of a word for which he is seeking related words. The system requires at least one starter word, and it returns all synonyms regardless of meaning from multiple databases. The synonyms are then arranged in a two dimensional array, and sorted according to frequency. The user then scans the list, starting from the top, and selects one or more entries from the sorted frequency array, and the re-runs. After several cycles of running and selecting new entries, the related words having the highest relevance to the searcher will rise to top of the frequency array. The end result is a group of related words having one or more meanings, and also having a relationship to a single concept being sought by the user.

### FIELD OF THE INVENTION

The present application relates to use of thesaurus databases to develop groups of conceptually related keywords for use in research.

### BACKGROUND OF THE INVENTION

Researchers, and in particular patent researchers, require tools for quickly and accurately locating words having relationship to a concept sought in a search project. As an example, if a researcher was searching for multiple concepts simultaneously, and a first concept relates to a “package”, the researcher might desire to use words like “box”, “container” or “receptacle.” The typical method for locating such synonyms is to use an online or paper based thesaurus. Several drawbacks exist in these traditional approaches. First, each word will have multiple meanings, and each meaning will have its own set of related words, requiring the researcher to have knowledge prior to hunting down his keywords. Second, this approach assumes that the first word sought is the primary word, in that it best represents the concept. However, in most cases, the researcher will discover words that better represent each concept, prompting him to again query the thesaurus with the new word. While the traditional approach can be effective, it also time consuming.

It is an object of the present invention to provide the researcher with a method of rapidly and accurately processing multiple queries of a thesaurus database.

It is a second object of the present invention to provide the researcher with options that he knows when he sees, rather than requiring the researcher to know before seeing.

### SUMMARY OF THE INVENTION

In the preferred embodiment of the present invention, a method of compiling a list of words with common relationships to a search concept comprises the first step of providing a system for compiling a list of words with common relationships. The system comprises an interactive client device having constituents including a display, a programmable thesaurus analysis module, a programmable interface module and a data storage element, said constituents digitally interconnected through a processor. The system further comprises a first program operable with the programmable thesaurus analysis module and a second program operable with the programmable interface module. The system further comprises both a user input/output interface and a network signally connected to the interactive client device. Lastly, the system comprises at least one thesaurus database signally connected to the network.

Operationally, when the first program instructs the programmable thesaurus analysis module to collect and manipulate data from the at least one thesaurus database through the network and store said data in the data storage element, and the second program displays selected data from input and storage in the display and receives instructions for the manipulation of data, a list of words may be selected, sorted and stored based on iterative incidences of the words.

The second step of the method comprises inputting seed words numbering n, n greater than or equal to one, into a first box in a user GUI through the input/output user interface in communication with the interface module. The third step comprises commanding, by means of said user interface, the analysis module to conduct a loop. In the loop, the at least one thesaurus database is consulted by means of the network to collect words with meanings similar to each of the n seed words, including their synonyms, to form a first virtual array of candidate words.

The fourth step of the method comprises instructing the analysis module, through the input/output interface, to conduct a while loop. In the while loop, frequency of incidence data is collected and stored for each of the candidate words in the first virtual array. Any duplications of the n words and all words with a non-zero incidence count are eliminated. A second virtual array of candidate words is formed from the residual and displayed in a second box in the user GUI.

The fifth step of the method comprises selecting preferred words from the second box in the user GUI on the basis of incidence count and posting said selected words to the first box. The sixth step comprises repeating all of the five steps above for each entry in the first box until the seed list is sufficiently populated and validated with incidence frequency. The seventh and last step comprises transferring the resulting list of words in the first box to a third box for registration as an inquiry string.

### DESCRIPTION OF THE DRAWINGS

FIG. 1 is a block diagram illustrating a thesaurus processing system in accordance with an exemplary embodiment of the invention.

FIG. 2 is an interface diagram in accordance with an exemplary embodiment of the invention.

FIG. 3 is a flow diagram illustrating a process that may be carried out in accordance with the exemplary system of FIG. 1

FIG. 4a-c are diagrams illustrating arrays manipulated by system shown in FIG. 1 when executing the process shown in FIG. 3

### DETAILED DESCRIPTION OF THE PREFERRED EMBODIMENT

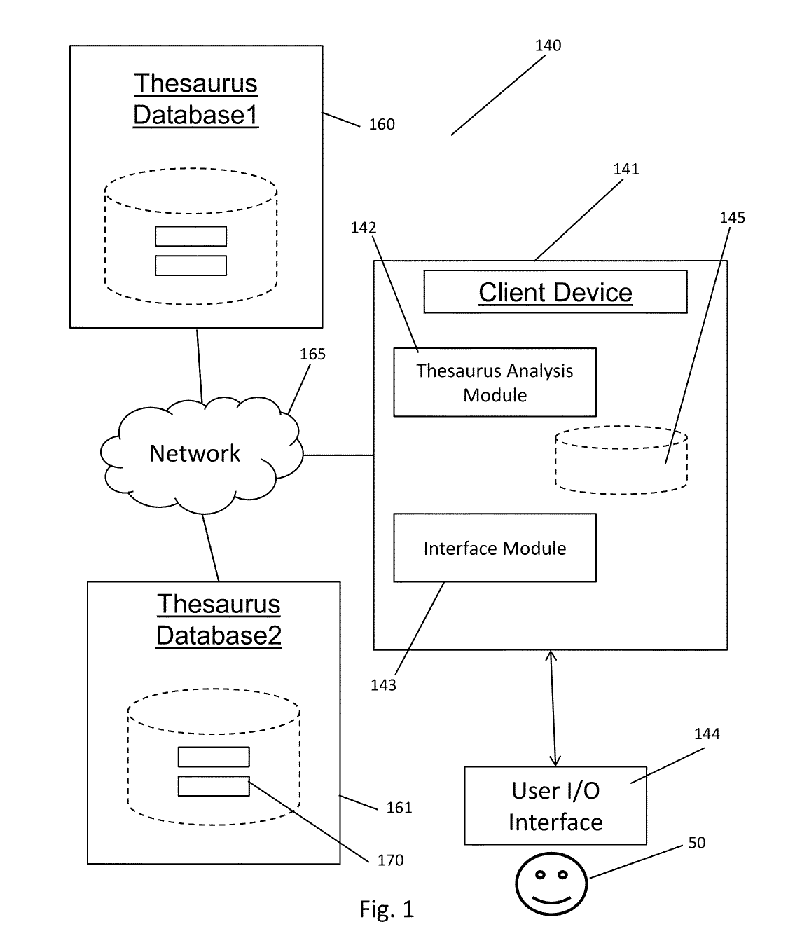

Referring to FIG. 1, a block diagram is shown illustrating a thesaurus processing system 140 in accordance with an exemplary embodiment of the invention. The thesaurus processing system 140 comprises a client device 141, which may be a computer. The client device 141 includes a thesaurus analysis module 142, an interface module 143, a user Input/Output (I/O) interface 144 and a data storage element 145. By way of example, the client device 141 may be a computing device having a processor such as personal computer, a phone, a mobile phone, or a personal digital assistant. The thesaurus processing system 140 may also comprise a thesaurus database1 160, a thesaurus database2 161 and a network 165. The thesaurus database1 160 and thesaurus Database2 161 are configured to deliver related words, labeled generally as 170.

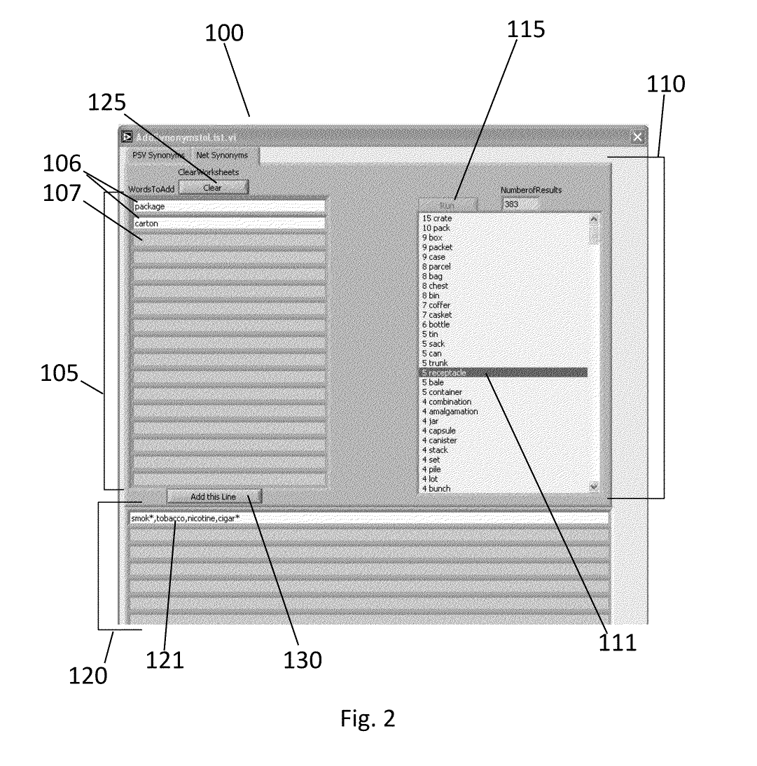

Referring to FIG. 2, a thesaurus GUI 100 is shown. The thesaurus GUI 100 has a user words box 105 where a user 50 may manually enter one or more user words 106. The user 50 may select one or more suggested words 111 from a suggested words box 110 and add them to the user words box 105 in available rows 107. In addition, the user 50 may press the run button 115 to generate new suggested words 111; or the user 50 may use the add button 130 to move all user words 106 to a user word groups box 120; or the user 50 may use a clear button 125 to remove all entries from the user words box 105 and the suggested words box 110.

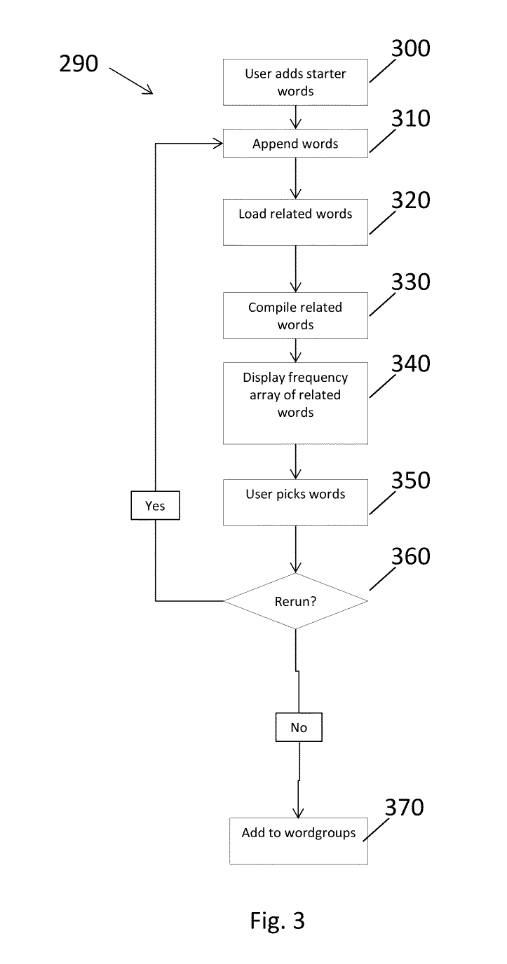

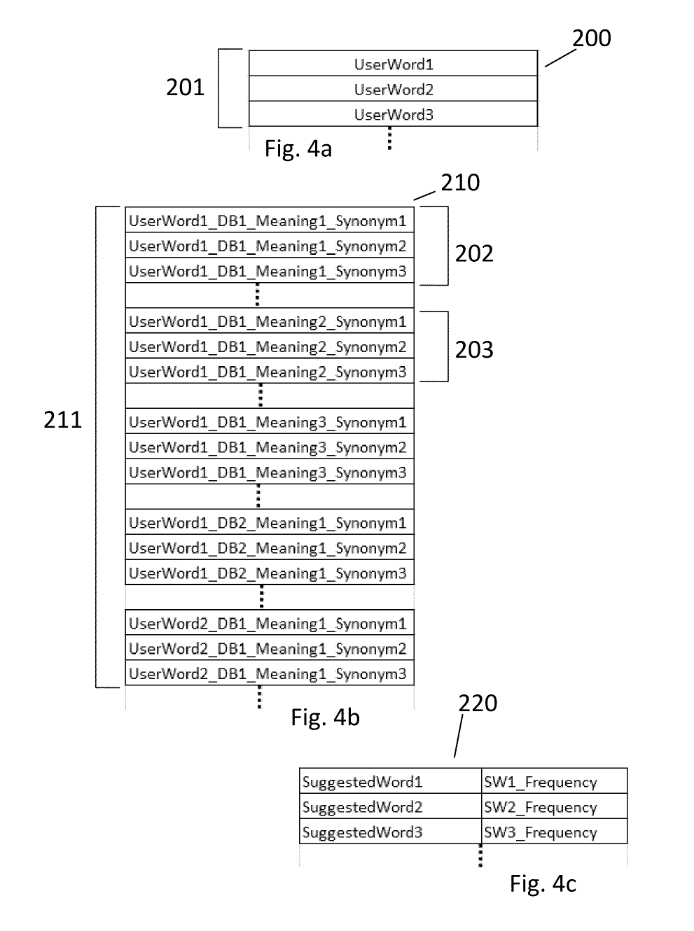

Referring to FIG. 3, an exemplary method of the present invention is shown and will now be discussed with further reference to FIGS. 4a-c.

Step 300: The user 50 manually enters one or more user words 106 into the user words box 105. The user 50 then presses the run button 115.

Step 310: The thesaurus analysis module 142 then enters all user words into the user words array 200, which is depicted in FIG. 4a as a one dimensional text array with user words array size 201 that represents the total number of user words 106 in the user words array 200.

Step 320: The thesaurus analysis module 142 then executes a loop with the number of cycles equal to the user words array size 201. The loop described as follows:
For each user word 106, the interface module 143 accesses thesaurus database 1 through network 165. The thesaurus database 1 returns a set 202 related to a first definition or meaning, the set referred to as UserWord1_DB1_Meaning1_Synonym1,
UserWord1_DB1_Meaning1_Synonym2 and UserWord1_DB1_Meaning1_Synonym3 . . . which are then loaded to a related words array 210 which is shown in FIG. 4b. The thesaurus database 1 returns a second set 203 related to a second definition or meaning, the set referred to as UserWord1_DB1_Meaning2_Synonym1, UserWord1_DB1_Meaning2_Synonym2 and UserWord1_DB1_Meaning2_Synonym3 . . . which are then appended to the related words array 210. This continues as meanings remain available for the first user word 106. The interface module 143 then repeats the previous steps with thesaurus database 2, and appends the related words array 210 with all new entries.

Step 330: The thesaurus analysis module 142 then executes a while loop, with the condition of related words array size 211>0. The while loop is described as follows:
For the first entry in related words array 210, count the total number of identical entries in related words array 210, deleting each entry as it is counted. Store the first entry along with its count, or frequency into a suggested words array 220, as seen in FIG. 4c.

Sort the suggested words array 220 high to low according the frequency column. Finally remove any entries in the suggested word array 220 that are also entered in the user words array 200.

Step 340: The thesaurus analysis module 142 then displays the suggested words array 220 in the suggested words box 110.

Step 350: The user 50 then scans the suggested words box 110 and picks one or more suggested words 111 and adds them to the user words box 105 by double clicking

Step 360: The user 50 then decides to either reload the suggested words box 110 according to the user words box 105. If yes, then return to step 310.

Step 370: The user 50 then moves the user words 106 out of the user words box and into a user group 121 in a user word groups box 120.

1. A system for compiling a list of words with common meaning, comprising:
an interactive client device having constituents including a display, a programmable thesaurus analysis module, a programmable interface module and a data storage element, said constituents digitally interconnected through a processor;
a first program operable with the programmable thesaurus analysis module;
a second program operable with the programmable interface module;
a user input/output interface signally connected to the interactive client device;
a network signally connected to the interactive client device; and
at least one thesaurus database signally connected to the network;
whereby, when the first program instructs the programmable thesaurus analysis module to collect and manipulate data from the at least one thesaurus database through the network and store said data in the data storage element, and the second program displays selected data from input and storage in the display and receives instructions for the manipulation of data, a list of words may be selected, sorted and stored based on iterative incidences of the words.

2. The system of claim 1, wherein there are at least two thesaurus data bases.

3. A method of compiling a list of words with common meaning, comprising the steps of:
providing the system of claim 1;
inputting seed words numbering n, n greater than or equal to one, into a first box in a user GUI through the input/output user interface in communication with the interface module;
commanding, by means of said user interface, the analysis module to conduct a loop, wherein the at least one thesaurus database is consulted by means of the network to collect words with meanings similar to each of the n seed words, including their synonyms, to form a first virtual array of candidate words;
instructing the analysis module through the input/output interface to conduct a while loop, wherein frequency of incidence data is collected and stored for each of the candidate words in the first virtual array, eliminating in the process any duplications of the n words and all words with a non-zero incidence count, and forming a second virtual array of candidate words from the residual to be displayed in a second box in the user GUI;
selecting preferred words from the second box in the user GUI on the basis of incidence count and posting said selected words to the first box;
repeating all steps above for each entry in the first box until the seed list is sufficiently populated and validated with incidence frequency; and
transferring the resulting list of words in the first box to a third box for registration as an inquiry string.
